(19) United States
(12) Patent Application Publication
(10) Pub. No.: US 2017/0097791 A1
(43) Pub. Date: Apr. 6, 2017

(54) DATA RETRIEVAL FOR A HOST DEVICE BY A PORTABLE MEMORY DEVICE INCLUDING A MEMORY REGION FOR STORING DATA TO BE WIRELESSLY TRANSMITTED AND RECEIVED

(71) Applicant: KABUSHIKI KAISHA TOSHIBA, Tokyo (JP)

(72) Inventors: Keisuke SATO, Yokohama Kanagawa (JP); Michio IDO, Yokohama Kanagawa (JP); Shigeto ENDO, Kamakura Kanagawa (JP)

(21) Appl. No.: 15/248,421

(22) Filed: Aug. 26, 2016

(30) Foreign Application Priority Data
Oct. 2, 2015 (JP) 2015-197003

(51) Int. Cl. G06F 3/06

(52) U.S. Cl. CPC G06F 3/0655; G06F 3/061; G06F 3/065; G06F 3/067

(57) ABSTRACT

Data associated with an accessory that is coupled with a host device are retrieved for the host device by a portable memory device coupled with the host device. The method for retrieving the data includes capturing a code containing the accessory ID, storing the accessory ID in a nonvolatile memory region of the portable memory device, copying the accessory ID from the nonvolatile memory region to a wirelessly-communicable memory region of the portable memory device, the accessory ID being output from the wirelessly-communicable memory region to a user computing device when the user computing device comes within a predetermined communication range of the wirelessly-communicable memory region, and upon detecting that content data associated with the accessory ID are returned from user computing device, storing the content data in the wirelessly-communicable memory region and copying the content data stored in the wirelessly-communicable memory region to the nonvolatile memory region.

### CROSS-REFERENCE TO RELATED APPLICATION

This application is based upon and claims the benefit of priority from Japanese Patent Application No. 2015-197003, filed Oct. 2, 2015, the entire contents of which are incorporated herein by reference.

### FIELD

Embodiments described herein relate generally to data retrieval for a host device by a portable memory device including a memory region for storing data to be wirelessly transmitted and received.

### BACKGROUND

In general, if a storage apparatus is physically connected to an electronic apparatus, the electronic apparatus is able to store data in the storage apparatus, or read out the data stored in the storage apparatus.

Such a storage apparatus includes, for example, a memory card having a function of carrying out wireless communication using a wireless antenna mounted thereon.

### DESCRIPTION OF THE DRAWINGS

FIG. 1 is a block diagram of an information processing system according to a first embodiment.

FIG. 2 is a flow chart illustrating a process of an operation carried out by the information processing system according to the first embodiment.

FIG. 3 schematically illustrates a content change operation carried out by an electronic apparatus in the information processing system according to the first embodiment.

FIG. 4 is a flow chart illustrating mirroring carried out by a controller of an electronic apparatus of the information processing system according to the first embodiment.

FIG. 5 is a block diagram of the electronic apparatus according to the first embodiment.

FIG. 6 is a block diagram illustrating a first configuration of an information processing apparatus according to the first embodiment.

FIG. 7 is a block diagram illustrating a second configuration of the information processing apparatus according to the first embodiment.

FIGS. 8A and 8B schematically illustrate an accessory according to the first embodiment.

FIG. 9 illustrates a first example of content acquisition carried out by an electronic apparatus according to a second embodiment.

FIG. 10 illustrates a second example of content acquisition carried out by the electronic apparatus according to the second embodiment.

FIG. 11 illustrates a third example of content acquisition carried out by the electronic apparatus according to the second embodiment.

FIG. 12 illustrates a fourth example of content acquisition carried out by the electronic apparatus according to the second embodiment.

FIG. 13 illustrates a data structure of data to be mirrored according to a third embodiment.

FIG. 14 illustrates a user interface of an information processing apparatus according to the third embodiment.

FIG. 15 is a flow chart illustrating a content output process according to the third embodiment.

FIG. 16 is a flow chart illustrating an acquisition process of changed setting information according to the third embodiment.

FIG. 17 is a flow chart illustrating a content output process according to a fourth embodiment.

### DETAILED DESCRIPTION

An embodiment provides an electronic apparatus able to detachably mount a storage apparatus having a wireless communication function, a storage apparatus having a wireless communication function that is detachably mounted on the electronic apparatus, and an information processing system including the electronic apparatus and the storage apparatus.

In general, a method according to an embodiment includes: capturing a code of an accessory that is coupled with a host apparatus, the code containing an accessory ID of the accessory; storing the accessory ID in a portable memory device that is coupled with the host apparatus, the portable memory device having a nonvolatile memory region in which the accessory ID is initially stored and a wirelessly-communicable memory region; copying the accessory ID from the nonvolatile memory region to the wirelessly-communicable memory region, the accessory ID being output from the wirelessly-communicable memory region to a user computing device when the user computing device comes within a predetermined communication range of the wirelessly-communicable memory region; upon detecting that content data associated with the accessory ID are returned from user computing device, storing the content data in the wirelessly-communicable memory region and copying the content data stored in the wirelessly-communicable memory region to the nonvolatile memory region; reading the content data stored in the nonvolatile memory region; and generating audio or visual information corresponding to the content data.

Hereinafter, respective embodiments will be described with reference to the drawings. In the following description, approximately or substantially the same functions and components are denoted by the same reference numerals, and a description will be given as necessary.

### First Embodiment

In the present embodiment, a description will be given on an electronic apparatus on which a storage apparatus having a wireless communication function (hereinafter, referred to as a wireless storage apparatus) is detachably mountable, a wireless storage apparatus which is detachably mountable on the electronic apparatus, and an information processing system including the electronic apparatus and the wireless storage apparatus. In the present embodiment, identification information is referred to as ID.

In the present embodiment, a description will be given on the information processing system which changes the setting of the electronic apparatus, by transmitting setting information on the electronic apparatus from an information processing apparatus to the wireless storage apparatus. In the present embodiment, a description will be given on a change of content which is output (reproduced) in the electronic apparatus, more specifically, a change of audio data which is output by the electronic apparatus, as an example of change of setting of the electronic apparatus. However, examples of changing the setting of the electronic apparatus include that the electronic apparatus variously changes an operation based on the setting information which is stored in the wireless storage apparatus.

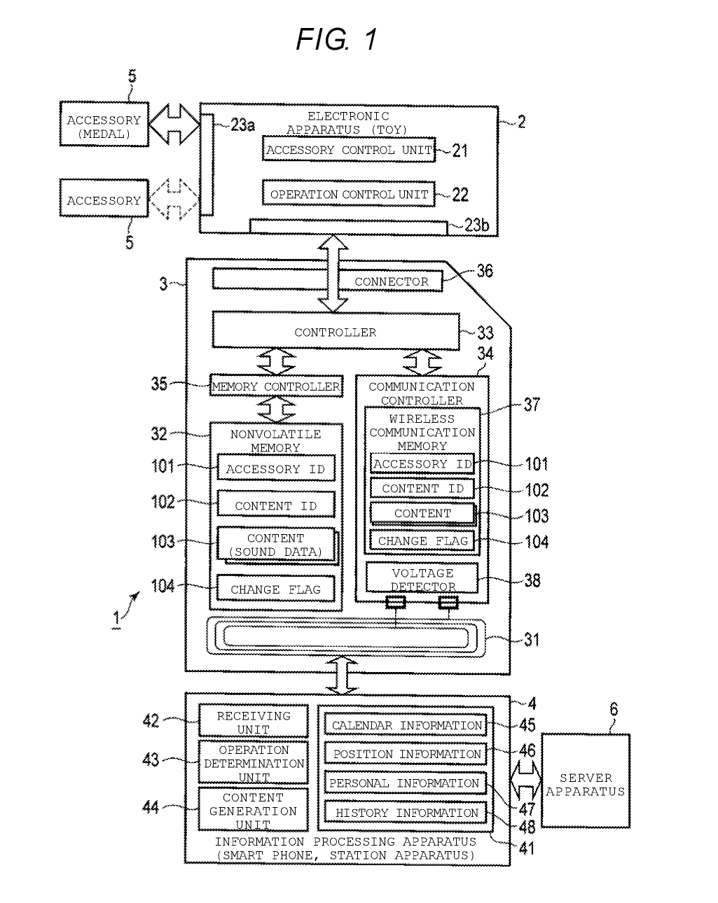

FIG. 1 is a block diagram of an information processing system according to the present embodiment.

An information processing system 1 includes an electronic apparatus 2, a wireless storage apparatus 3, an information processing apparatus 4, and a server apparatus 6.

The electronic apparatus 2 may be, for example, toys, smart watches, game machines, mobile phones, computers, wearable terminals or the like. In the present embodiment, it is assumed that the electronic apparatus 2 is a toy. For example, the electronic apparatus 2 may be a watch-type toy.

The electronic apparatus 2 includes amount unit 23b into which the wireless storage apparatus 3 is detachably mountable.

A user is able to insert the wireless storage apparatus 3 into the mount unit 23b, and remove (draw) the wireless storage apparatus 3 from the mount unit 23b.

If the wireless storage apparatus 3 is mounted on the mount unit 23b, the electronic apparatus 2 is electrically connected to the wireless storage apparatus 3, and can transmit and receive commands, addresses, data, information, instructions, signals, and the like to and from the wireless storage apparatus 3.

The electronic apparatus 2 also includes a mount unit 23a into which the accessory 5 is detachably mountable.

The user is able to mount the accessory 5 into the mount unit 23a of the electronic apparatus 2, and replace the mounted accessory 5 with another accessory.

The accessory 5 is, for example, merchandise to be applied or attached to the electronic apparatus 2. The accessory 5 is, for example, medals, keychains, straps, cards, or the like. In the present embodiment, it is assumed that the accessory 5 is a medal.

For example, the accessory 5 has a code indicating an accessory ID for identifying the accessory 5, or information on a groove, or the like. The electronic apparatus 2 is able to read the accessory ID. The accessory ID may be, for example, a bit code, a bar code, or a QR Code®, which may be attached to the accessory 5.

The accessory ID may be an ID specific to the accessory 5, or an ID indicating the type (for example, the version, or the like) of the accessory 5.

Further, the accessory 5 may have an electronic apparatus ID in addition to the accessory ID. In this case, in addition to the accessory ID, the electronic apparatus ID is also read by the electronic apparatus 2.

Alternatively, the accessory ID may include the electronic apparatus ID. In this case, when the accessory ID includes the electronic apparatus ID, the data management and data communication can be made efficient and simplified.

The electronic apparatus ID may be an ID specific to the electronic apparatus 2, or an ID indicating the type (for example, the version, or the like) of the electronic apparatus 2. The electronic apparatus 2 manages the electronic apparatus ID, and the electronic apparatus 2 may transmit the electronic apparatus ID to the wireless storage apparatus 3.

The electronic apparatus 2 executes an operation according to data, based on the data stored in the wireless storage apparatus 3. For example, the electronic apparatus 2 outputs the content that is stored in the wireless storage apparatus 3, depending on the operation by the user, and changes the states correlated with the content.

Examples of the operation by the user include turning on and off the electronic apparatus 2, mounting an accessory, removing an accessory, or pressing down an operation button.

The content may be image data (still image data, and moving image data), audio data (music data, voice data, and the like), video data, and the like. The content may represent a character. In the present embodiment, it is assumed that the content is audio data as an example.

The status may be growth information on a character correlated with the content, or the like.

The electronic apparatus 2 may access the wireless storage apparatus 3 by polling or depending on the operation by the user, recognize the change of setting information, and output content based on the changed setting information.

The electronic apparatus 2 may access the wireless storage apparatus 3, by polling or in response to the operation by the user, recognize the change of setting information, and store the changed setting information, in a memory of the electronic apparatus 2.

The electronic apparatus 2 may access the wireless storage apparatus 3, by polling or in response to the operation by the user, recognize the change of setting information, and store content correlated with the changed setting information, in the memory of the electronic apparatus 2.

The electronic apparatus 2 may read the changed content which is stored in a predetermined memory region of the wireless storage apparatus 3, and output the changed content.

The electronic apparatus 2 may read the changed content which is stored in a predetermined memory region of the wireless storage apparatus 3, and store the changed content in a predetermined memory region of the electronic apparatus 2.

The electronic apparatus 2 may bi-directionally communicate with the accessory 5, as well as the wireless storage apparatus 3. The communication between the electronic apparatus 2 and the accessory 5 is not limited to interactive communication. For example, the electronic apparatus 2 may read the information attached to the accessory 5. The information attached to the accessory 5 may be, for example, an accessory ID, and audio data correlated with the accessory 5.

The electronic apparatus 2 includes an accessory control unit 21 and an operation control unit 22.

The accessory control unit 21 recognizes the accessory ID of the accessory 5 mounted on the electronic apparatus 2, and stores the accessory ID in a nonvolatile memory 32 of the wireless storage apparatus 3.

The operation control unit 22 recognizes the accessory ID of the accessory 5 mounted on the electronic apparatus 2, and the content ID indicating the content to be output correlated with the accessory ID or the address, based on the information stored in the wireless storage apparatus 3, reads the content correlated with the recognized content ID or address from the wireless storage apparatus 3, and outputs the read content.

The wireless storage apparatus 3 may be, for example, various storage apparatuses such as a memory card (an SD memory card, a multimedia card, or the like) and a universal serial bus (USB) memory. In the present embodiment, it is assumed that the wireless storage apparatus 3 is a memory card.

In the present embodiment, the wireless storage apparatus 3 performs, for example, wireless communication conforming to a near field communication (NFC), which is the short-range wireless communication standard at a frequency of 13.56 MHz or the like. However, the wireless communication by the wireless storage apparatus 3 may be another wireless communication, such as, for example, a wireless local area network (LAN). The NFC communication enables communication at lower power than a general wireless LAN communication.

If the wireless storage apparatus 3 is mounted on the electronic apparatus 2, the wireless storage apparatus 3 is electrically connected to the electronic apparatus 2, and is supplied with power from the electronic apparatus 2. The wireless storage apparatus 3 has a function of storing data from the electronic apparatus 2, and a function of transmitting the read data to the electronic apparatus 2. The wireless storage apparatus 3 has a function of communicating data using power generated (induced) by electromagnetic induction of the wireless antenna 31 even if power is not supplied from the electronic apparatus 2. In other words, the wireless storage apparatus 3 performs, for example, wireless communication, and transmits or receives data to or from the information processing apparatus 4. In the wireless storage apparatus 3, at least some components are operable using the power generated by the electromagnetic induction based on radio waves from the information processing apparatus 4, even if power is not supplied from the electronic apparatus 2.

Although the wireless storage apparatus 3 transmits and receives data to and from the electronic apparatus 2 according to a wired interface such as, for example, an SD interface in the present embodiment, other interfaces may be used. Further, although the wireless storage apparatus 3 transmits and receives data to and from the information processing apparatus using, for example, an NFC interface, other wireless communication interfaces may be used.

The wireless storage apparatus 3 includes a wireless antenna 31, a nonvolatile memory 32, a controller 33, a communication controller 34, a memory controller 35, and a connector 36. The communication controller 34 includes a wireless communication memory 37 and a voltage detector 38. The communication controller 34 and the wireless communication memory 37 may be provided separately. It is possible to combine or separate the controller 33, the communication controller 34, and the memory controller 35.

The controller 33, the memory controller 35, and the nonvolatile memory 32 operate, when the wireless storage apparatus 3 is supplied with power from the electronic apparatus 2. When the wireless storage apparatus 3 is supplied with power only through the wireless antenna 31, and not supplied with power from the electronic apparatus 2, the controller 33, the memory controller 35, and the nonvolatile memory 32 may not operate. Meanwhile, the communication controller 34 is operable, even if the wireless storage apparatus 3 is supplied with power only through the wireless antenna 31, and not supplied with power from the electronic apparatus 2. In other words, if the wireless antenna 31 receives wireless radio waves of a predetermined frequency corresponding to the NFC, the communication controller 34 is operable, and the wireless storage apparatus 3 can perform communication by the NFC.

The nonvolatile memory 32 may be, for example, a nonvolatile semiconductor memory. The nonvolatile memory 32 is, for example, a NAND type flash memory, but may be another nonvolatile semiconductor memory such as a NOR-type flash memory, a magnetoresistive random access memory (MRAM: a magnetoresistive memory), a phase-change random access memory (PRAM: a phase-change memory), a resistive random access memory (ReRAM: a resistance-change memory), and a ferroelectric random access memory (FeRAM). For example, the nonvolatile memory 32 may be another nonvolatile memory, a magnetic memory, or the like. For example, the nonvolatile memory 32 may be a flash memory of a three-dimensional structure.

The nonvolatile memory 32 operates, for example, when the electronic apparatus 2 supplies power to the wireless storage apparatus 3.

In the present embodiment, the nonvolatile memory 32 stores, for example, an accessory ID 101 of an accessory that the current electronic apparatus 2 uses, a content ID 102 of content to be output, various kinds of contents 103 which are output by the electronic apparatus 2, and a change flag 104 (change information). In the present embodiment, the various kinds of contents 103 are associated with the content IDs 102, respectively, and may be readable based on the content IDs 102. The various kinds of contents 103 are stored in a predetermined memory region, and may be readable based on an address indicating the predetermined memory region.

The change flag 104 indicates, for example, whether or not there is a change (update) of the content 103.

The nonvolatile memory 32 may include the address indicating the storage location of the content 103 corresponding to the content ID 102 as described below.

The nonvolatile memory 32 may store, for example, the electronic apparatus ID of the current electronic apparatus 2 (version information of the electronic apparatus 2).

By referring to the information stored in the nonvolatile memory 32, the electronic apparatus 2 can recognize which content 103 is to be output for each accessory ID 101.

The controller 33 receives commands, addresses, data, information, instructions, signals, or the like, from the electronic apparatus 2, the memory controller 35, and the communication controller 34.

The controller 33 outputs the commands, the addresses, the data, the information, the instructions, the signals, or the like, to the memory controller 35, the communication controller 34, and the electronic apparatus 2, based on the received command.

In the present embodiment, the controller 33 may operate, based on software such as firmware, an operating system, and an application program.

The controller 33 stores the accessory ID 101, the content ID 102, the content 103, the change flag 104, data of time when the accessory ID is stored, and a copy flag, in the nonvolatile memory 32.

The copy flag indicates a state whether or not the data stored in the nonvolatile memory 32 have been copied (may be moved or transferred) to the wireless communication memory 37.

The controller 33 performs mirroring to cause contents stored in the nonvolatile memory 32 and the wireless communication memory 37 to be same as each other.

For example, when data to be mirrored is stored or changed in one of the nonvolatile memory 32 and the wireless communication memory 37, the controller 33 stores data with the same contents or changes data to the same contents in the other memory by the mirroring. In the present embodiment, examples of data to be mirrored include the accessory ID 101, the content ID 102, the content 103, the change flag 104, the data of time when the accessory ID was stored, and the like.

The controller 33 performs the mirroring, in a state where the wireless storage apparatus 3 is supplied with power, for example, in a state where the user mounts the wireless storage apparatus 3 on the electronic apparatus 2. When the wireless storage apparatus 3 becomes a state of being supplied with power, the controller 8 may necessarily perform the mirroring. Since the mirroring is necessarily performed immediately after turning on the power of the electronic apparatus 2, the electronic apparatus 2 can reflect the change of the wireless communication memory 37 in the nonvolatile memory 32 without omission during the power off of the electronic apparatus 2. Even when the electronic apparatus 2 does not supply power to the wireless storage apparatus 3, the wireless storage apparatus 3 can receive data from the information processing apparatus 4. For that reason, the controller 33 may execute, for example, a process such as the mirroring without power supply from the electronic apparatus 2.

The timing of mirroring is not limited to the time of the power supply to the wireless storage apparatus 3. For example, the mirroring may be performed when the wireless storage apparatus 3 receives a wireless communication instruction from the information processing apparatus 4, or may be performed at the timing of power OFF of the wireless storage apparatus 3, may be performed each time a predetermined time elapses, may be performed in response to the mounting of the accessory 5, or may be performed in response to the removal of the accessory 5.

The controller 33 may store data in the wireless communication memory 37 after compressing the data. The controller 33 executes the compression, by using, for example, the Huffman code. When reading the data stored in the wireless communication memory 37, the controller 33 decompresses the compressed data and reads out the decompressed data. The compression and decompression of data may be performed by the controller 33, or the wireless storage apparatus 3 may be equipped with a compressor and a decompressor different from the controller 33, and the controller 33 may control the compressor so as to compress data and the decompressor so as to decompress data.

The memory controller 35 controls the nonvolatile memory 32. The memory controller 35 stores data into the nonvolatile memory 32, for example, based on the commands or the like which are input from the controller 33. The memory controller 35 reads data from the nonvolatile memory 32 and outputs the data to the controller 33, for example, based on the commands or the like which are input from the controller 33. The memory controller 35 may communicate with the communication controller 34 or the electronic apparatus 2, without passing through the controller 33.

The wireless antenna 31 is, for example, a PCB pattern antenna. The operable frequency band of the wireless antenna 31 may be a predetermined frequency band corresponding to the NFC.

The wireless antenna 31 can generate power by electromagnetic induction, based on, for example, the radio waves from the information processing apparatus 4. The wireless antenna 31 supplies the generated power to the communication controller 34.

The wireless antenna 31 receives commands, addresses, data, information, instructions, signals, or the like, from the information processing apparatus 4. The wireless antenna outputs the received command, and the like, to the communication controller 34.

The communication controller 34 performs communication with the information processing apparatus 4 and the like through the wireless antenna 31. The communication controller receives commands, addresses, data, information, instructions, signals, or the like from the controller 33 and the wireless antenna 31. The communication controller 34 outputs, for example, data and the like, to the controller 33 and the wireless antenna 31, based on the received command. The communication controller 34 receives data from the wireless communication memory 37, based on the received command, address, and the like, and outputs the received data to the controller 33 and the wireless antenna 31. The communication controller 34 stores data in the wireless communication memory 37, based on the received command, address, and the like.

In the present embodiment, the communication controller 34 receives a changed content ID which is determined by the information processing apparatus 4 in correlation with the accessory ID, from the information processing apparatus 4 through the wireless antenna 31, and stores the received changed content ID as the content ID 102 of the content to be output, in the wireless communication memory 37. The changed content ID 102 correlated with the accessory ID is stored in the nonvolatile memory 32, by the mirroring.

The commands, the addresses, the data, the information, the instructions, the signals, or the like, which are communicated between the electronic apparatus 2, the controller 33, the memory controller 35, the communication controller 34, the wireless antenna 31, and the like, do not necessarily in the same data format. As long as commands, addresses, data, information, instructions, signals, or the like that both communication parties can recognize, the commands, addresses, data, information, instructions, signals, or the like, which are communicated by other parties, may not be in the same format.

When receiving commands and data through the controller 33 or the wireless antenna 31, the communication controller 34 stores data in the wireless communication memory 37. The communication controller 34 may not necessarily perform the writing of data into the wireless communication memory 37.

The wireless communication memory 37 is, for example, a nonvolatile memory. The wireless communication memory 37 stores data under the control of the communication controller 34 or the memory controller 35. The data storing in the wireless communication memory 37 may be temporary. For example, although an electrically erasable programmable read-only memory (EEPROM) is used as the wireless communication memory 37, it is possible to use various kinds of memories similarly to the nonvolatile memory 32.

It is desirable that the nonvolatile memory used in the wireless communication memory 37 has lower power consumption per unit volume than that of the nonvolatile memory 32, so as to be operable with the power supplied from the wireless antenna 31. Specifically, a NOR type memory may be used.

In the present embodiment, the wireless communication memory 37 stores part or all of the data stored in the nonvolatile memory 32. For example, the wireless communication memory 37 stores an accessory ID 101, a content ID 102, content 103, a change flag 104, data of time when the accessory ID was stored, and a transmission flag.

The transmission flag indicates whether or not the wireless storage apparatus 3 transmits, to the information processing apparatus 4, the accessory ID, the content ID, the content, the change flag, and the data of time when the accessory ID was stored, which are stored in the wireless communication memory 37.

The wireless communication memory 37 may store, for example, relevant data of the wireless storage apparatus 3 (part of data stored in the nonvolatile memory 32 (for example, image data, audio data (music data, voice data, or the like), video data, or the like), data relevant to the data stored in the nonvolatile memory 32, data relevant to the nonvolatile memory 32 and wireless storage apparatus 3), data relevant to the information processing apparatus 4, or data relevant to the accessory 5 mounted on the electronic apparatus 2, and commands which are received from the controller 33, the information processing apparatus 4, or the like.

Specific examples of the data stored in the wireless communication memory 37 are as follows. It should be noted that these are merely examples, and data stored in the wireless communication memory 37 is not limited thereto.

The data relevant to the nonvolatile memory 32 is, for example, file name data, a first or last part of image data, thumbnail image data of image data, file generation time data, imaging time data, data ID, and the like.

The data relevant to the audio data stored in the nonvolatile memory 32 is, for example, file name data, a first or last part of audio data, output time data of audio data, file generation time data, data ID, and the like.

The data relevant to the video data stored in the nonvolatile memory 32 is memory capacity data, remaining capacity data, data of the number of files, and the like of the nonvolatile memory 32.

The data related to the wireless storage apparatus 3 is recognition ID data (identification number which is arbitrarily assigned to each wireless storage apparatus 3, for example, a unique product ID assigned at the time of manufacture, or ID which is arbitrarily assigned later to each wireless storage apparatus 3), or comments (text data associated with the wireless storage apparatus 3, which is stored by the user in the wireless storage apparatus 3 through the electronic apparatus 2).

Data related to the electronic apparatus 2 is the recognition ID data of the electronic apparatus 2, change information of firmware of the electronic apparatus 2, flag information generated based on these pieces of information, or the like.

Data related to the accessory 5 is the recognition ID data of the accessory 5, data included in the code provided in the accessory 5, flag information generated from the data, or the like.

The voltage detector 38 is electrically connected to the wireless antenna 31. The voltage detector 38 detects the voltage supplied from the wireless antenna 31 to the communication controller 34. The voltage detector 38 issues a reset command of communication by the NFC, until the voltage reaches a predetermined value at which the communication controller 34 is operable. The communication controller 34 does not perform communication by the NFC while receiving the reset command. This reset command allows to prevent an abnormal activation and operation of communication by the NFC. When the voltage reaches a predetermined value, the voltage detector 38 may output an operational command to the communication controller 34. Only when receiving the operational command, the communication controller 34 performs communication by the NFC.

The connector 36 is, for example, a standardized connection terminal, and is electrically connectable with electronic apparatus 2.

The information processing apparatus 4 is, for example, cellular phones, computers, game machines, station apparatuses, wearable terminals, or the like. The station apparatuses are, for example, devices which are located in shopping malls, electronics stores, toy stores, or the like. The information processing apparatus 4 is able to transmit and receive commands, addresses, data, information, instructions, signals, or the like to and from the wireless storage apparatus 3.

The information processing apparatus 4 includes, for example, a storage unit 41, a receiving unit 42, an operation determination unit 43, and a content generation unit 44.

The storage unit 41 stores calendar information 45, position information 46, personal information 47, and history information 48.

In the calendar information 45, date and an event associated with the date. Examples of the event include New Year, traditional end of winter, Doll Festival, Children's Day, Christmas, New Year's Eve, or the like.

The position information 46 indicates the position of the information processing apparatus 4, which is obtained by, for example, a global positioning system (GPS).

The personal information 47 includes information such as the birthday, the age, the address, and the schedule of the user of the information processing apparatus 4 and the user of the electronic apparatus 2.

The history information 48 includes information such as reception history of each accessory ID, the status of each accessory ID, and use history of the electronic apparatus by the user.

The receiving unit 42 receives an accessory ID indicating the accessory 5 mounted on the electronic apparatus, from the wireless storage apparatus 3.

The operation determination unit 43 determines the content ID (for example, the changed content ID) correlated with the accessory ID of the accessory 5 mounted on the electronic apparatus 2, based on the calendar information 45, the position information 46, the personal information 47, and the history information 48, which are stored in the storage unit 41. The operation determination unit 43 transmits the determined content ID to the wireless storage apparatus 3.

The content generation unit 44 generates content, based on the user's operation or the calendar information 45, the position information 46, the personal information 47, and the history information 48, which are stored in the storage unit 41, and determines a content ID of the generated content. The content generation unit 44 transmits the generated content and the content ID of the content, to the wireless storage apparatus 3.

For example, the content generation unit 44 synthesizes the audio data to generate new content.

The information processing apparatus 4 transmits and receives commands, addresses, data, information, instructions, signals, or the like to and from the server apparatus 6 in a wireless manner or wired manner. The wireless communication standard such as, for example, a wireless LAN, a 3rd Generation (3G), a long term evolution (LTE) is used for the communication between the information processing apparatus 4 and the server apparatus 6.

The server apparatus 6 functions as a service terminal that provides a variety of services to each user. In addition, the server apparatus 6 may be omitted in the present embodiment.

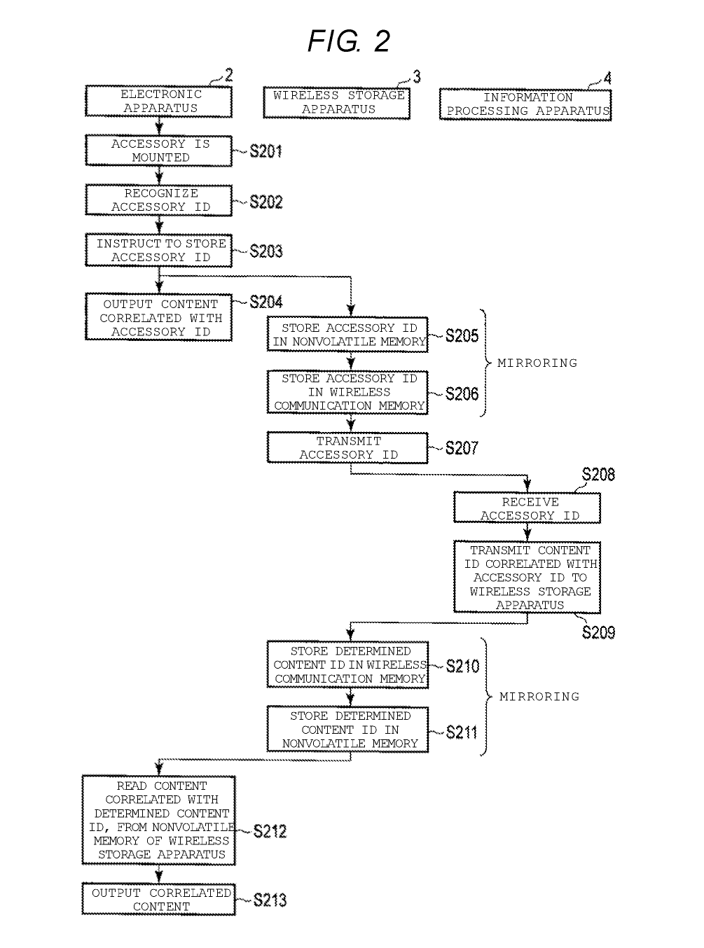

FIG. 2 is a flow chart illustrating a process of an operation carried out by the information processing system 1 according to the present embodiment.

In step S201, the accessory 5 is mounted on the electronic apparatus 2.

In step S202, the accessory control unit 21 of the electronic apparatus 2 recognizes the accessory ID of the accessory 5.

In step S203, the accessory control unit 21 instructs the wireless storage apparatus 3 to store the accessory ID.

In step S204, the operation control unit 22 of the electronic apparatus 2 outputs content correlated with the accessory ID.

If the electronic apparatus 2 instructs to store the accessory ID 2 in step S203, the wireless storage apparatus 3 stores the accessory ID in the nonvolatile memory 32 based on the instruction received from the electronic apparatus 2, in step S205.

In step S206, the wireless storage apparatus 3 stores the accessory ID in the wireless communication memory 37 by performing the mirroring between the nonvolatile memory 32 and wireless communication memory 37.

In step S207, the wireless storage apparatus 3 transmits the accessory ID to the information processing apparatus 4, by performing wireless communication with the information processing apparatus 4.

In step S208, the receiving unit of the information processing apparatus 4 receives the accessory ID from the wireless storage apparatus 3.

In step S209, the operation determination unit 43 of the information processing apparatus 4 determines the content ID correlated with the accessory ID, based on the information stored in the storage unit 41, and transmits a content change instruction (change flag 104) and the content ID 102 determined for the accessory ID 101, to the wireless storage apparatus 3 by performing wireless communication with the wireless storage apparatus 3.

In step S210, the wireless storage apparatus 3 receives the content change instruction (change flag 104) and the content ID 102 determined based on the accessory ID 101 from the information processing apparatus 4, and stores the received data in the wireless communication memory 37.

In step S211, the wireless storage apparatus 3 stores the content change instruction (change flag 104) and the content ID 102 determined based on the accessory ID 101 in the nonvolatile memory 32, by performing the mirroring between the nonvolatile memory 32 and the wireless communication memory 37.

In step S212, the operation control unit 22 of the electronic apparatus 2 recognizes the content indicated by the determined content ID 102 correlated with the accessory ID 101, based on the content change instruction stored in the nonvolatile memory 32 of the wireless storage apparatus 3, and reads out the recognized content 103 from the nonvolatile memory 32.

In step S213, the operation control unit 22 of the electronic apparatus outputs the recognized content.

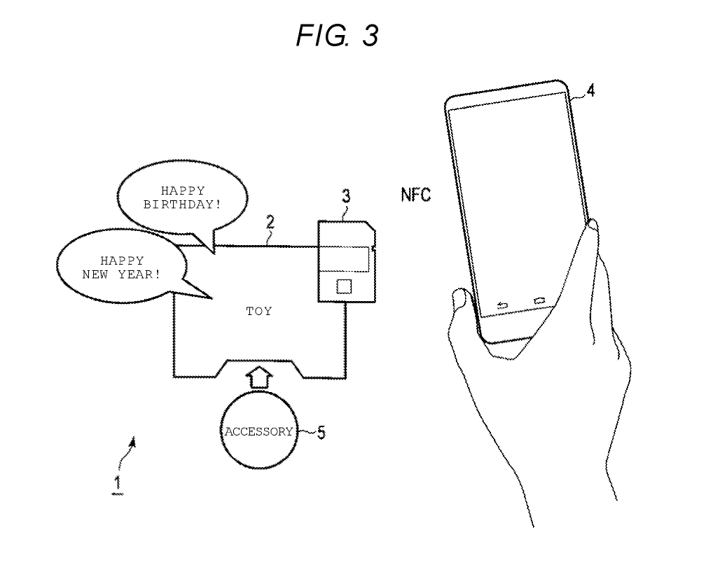

FIG. 3 schematically illustrates a content change operation using the electronic apparatus 2 of the information processing system 1 according to the present embodiment.

The accessory 5 and the wireless storage apparatus 3 are mounted on the electronic apparatus 2. For example, the information processing apparatus 4 determines the content ID of the audio data to be output by the electronic apparatus 2, based on various determination methods such as a user designating method, a random method, and a repeating method. Alternatively, the information processing apparatus 4 determines the content ID correlated with the accessory ID, based on at least one of the calendar information 45, the position information 46, the personal information 47, and the history information 48.

The user holds the information processing apparatus 4 close to the electronic apparatus 2 on which the wireless storage apparatus 3 is mounted. Then, the information processing apparatus 4 performs wireless communication with the wireless storage apparatus 3, and changes the content ID 102 correlated with the accessory ID 101 stored in the wireless storage apparatus 3. The electronic apparatus 2 reads the content 103 indicated by the changed content ID 102 correlated with the accessory ID 101 of the mounted accessory 5 from the wireless storage apparatus 3 and outputs the audio data which is the read content 103, to switch the audio data.

For example, if the date on which the user uses the electronic apparatus 2 is January 1, the electronic apparatus outputs voice data of “Happy New Year”. For example, if the date on which the user uses the electronic apparatus 2 is a birthday of the user, the electronic apparatus 2 outputs audio data of “Happy Birthday”.

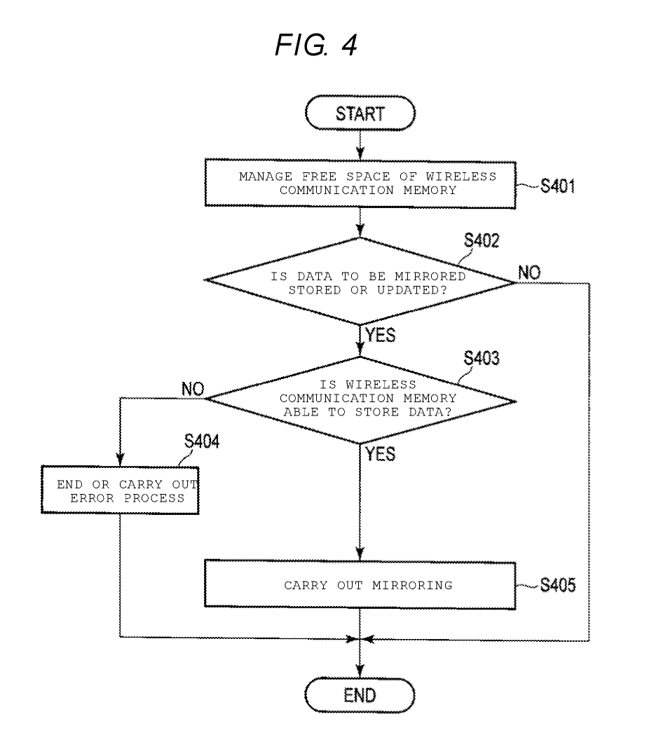

FIG. 4 is a flow chart illustrating steps of the mirroring carried out by the controller 33 according to the present embodiment.

In step S401, the controller 33 manages the status indicating whether or not the wireless communication memory 37 is able to store data, based on the position of a free space and the data capacity of the free space of the wireless communication memory 37, and the number of accessory IDs stored in the wireless communication memory 37. For example, if the data capacity of the free space is a first threshold or more, the controller 33 determines that the wireless communication memory 37 is capable of storing data. For example, if the number of accessory IDs stored in the wireless communication memory 37 is a second threshold or less, the controller 33 determines that the wireless communication memory 37 is capable of storing data.

In step S402, the controller 33 determines whether or not data to be mirrored is stored or changed in at least one of the nonvolatile memory 32 and the wireless communication memory 37.

When the data to be mirrored is not stored or changed in at least one of the memories 32 and 37, the process is ended.

When the data to be mirrored is stored or changed in at least one of the memories 32 and 37, the controller 33 determines whether or not the wireless communication memory 37 is able to store data, based on the status, in step S403.

If the wireless communication memory 37 is not able to store data, the controller 33 ends the process or executes an error process in step S404. The error process may be, for example, a process of instructing the electronic apparatus 2 or the information processing apparatus 4 to output sound or display a screen indicating that data was not successfully changed.

If the wireless communication memory 37 is able to store data, the controller 33 carries out the mirroring in step S405.

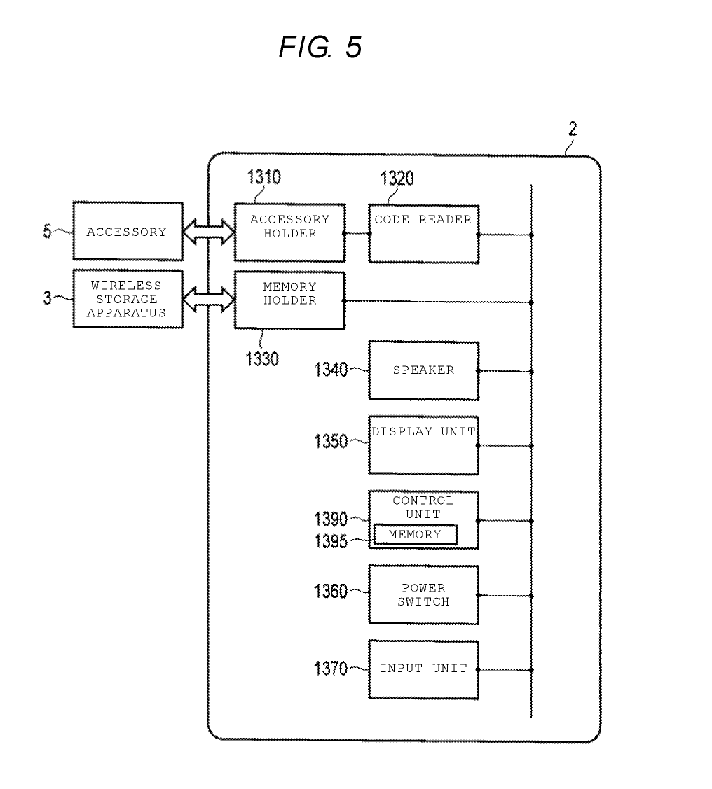

FIG. 5 is a block diagram of the electronic apparatus 2 according to the present embodiment.

The electronic apparatus 2 includes an accessory holder 1310, a code reader 1320, a memory card holder 1330, a speaker 1340, and a control unit 1390.

It is possible to insert a storage apparatus, for example, a memory card, into the memory card holder 1330 from the outside. In the present embodiment, the memory card holder 1330 holds the wireless storage apparatus 3, for example, an NFC chip-mounted memory card. The memory card holder 1330 corresponds to the mount unit 23b in FIG. 1.

The accessory holder 1310 holds, for example, the accessory 5 which is inserted from the outside. Alternatively, the accessory holder 1310 may hold the accessory 5, without being inserted from the outside. For example, the accessory holder 1310 may be a ring-shaped holder that holds the accessory 5, which is a keychain. The accessory holder 1310 corresponds to the mount unit 23a in FIG. 1.

The accessory 5 is, for example, a card on which a character is depicted. For example, one character is depicted on a single accessory 5. However, without being limited to this case, a plurality of characters may be depicted on a single accessory 5. Information on the depicted character is indicated on a single accessory 5. The accessory 5 has the information in the form of, for example, an optically-readable code. However, without being limited to this case, for example, the accessory 5 may include an NFC chip, and information on the character may be stored in the NFC chip. If the information on the character is stored in the NFC chip or an NFC tag, it is possible to change the data later, and for example, it is possible to easily upgrade of the character on the information processing system 1.

When the information on the drawn character is indicated by an optically-readable code, and the accessory 5 is held in the accessory holder 1310, the code of the accessory 5 is positioned to oppose to (face) the code reader 1320.

The code reader 1320 reads the information on the drawn character, from the code of the accessory 5, upon receipt of an instruction from the outside, and transmits the information on the character to the wireless storage apparatus 3. For example, the information on the character may include address information to be read from the nonvolatile memory 32 of the wireless storage apparatus 3.

The controller 33 of the wireless storage apparatus 3 receives the information on the character, and reads the correlated information. Specifically, the controller 33 gives a read instruction to the memory controller 35, and outputs an address, and the memory controller 35 reads data from the memory of the address correlated with the information on the character, and outputs the read data to the controller 33. The wireless storage apparatus 3 outputs the data to the speaker 1340.

The speaker 1340 converts the data into voice data through a DA converter (not illustrated), and generates sound corresponding to the converted data. The user can listen to the sound correlated with the accessory 5 mounted on the electronic apparatus 2.

In addition, the speaker 1340 may generate the sound, based on sound data directly read from the accessory 5.

The electronic apparatus 2 may include a display unit (display) 1350. If audio data and moving image data are included in the read data, the electronic apparatus 2 may output the audio data from the speaker 1340, and display a moving image based on the moving image data on the display unit 1350. The electronic apparatus 2 may, without outputting the audio data from the speaker 1340, display the moving image on the display unit 1350.

The electronic apparatus 2 may include a power switch 1360 that can turn on or off the electronic apparatus 2, and an input unit 1370. The input unit 1370 may include a plurality of input means such as, for example, buttons and switches.

The control unit 1390 controls the code reader 1320, the speaker 1340, the display unit 1350, the power switch 1360, and the input unit 1370. The control unit 1390 communicates with the wireless storage apparatus 3.

In the present embodiment, the control unit 1390 may include the accessory control unit 21 and the operation control unit 22 in FIG. 1. The control unit 1390 may be implemented by hardware, or may be even implemented by the processor executing the software.

The control unit 1390 may include a memory 1395. For example, the memory 1395 may be provided separately from the control unit 1390. The memory 1395 may be used as, for example, a cache memory that temporarily stores data. The memory 1395 may be, for example, a serial peripheral interface (SPI) flash memory.

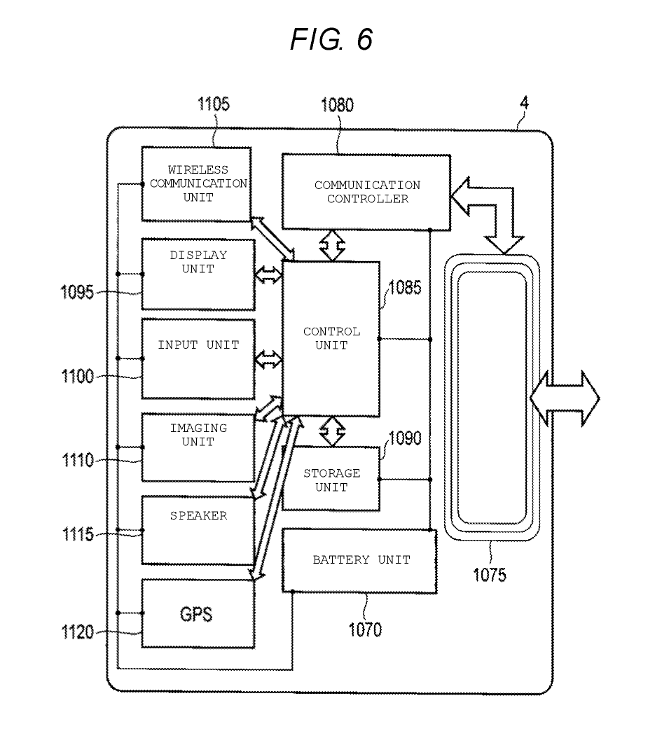

FIG. 6 is a block diagram illustrating a first configuration of the information processing apparatus 4 according to the present embodiment. The information processing apparatus 4 is a device having a wireless communication function, such as a smart phone, a personal digital assistant (PDA), a tablet, and a computer.

The information processing apparatus 4 includes a battery unit 1070, a wireless antenna 1075, a communication controller 1080, a control unit 1085, a storage unit 1090, a display unit 1095, an input unit 1100, a wireless communication unit 1105, an imaging unit 1110, a speaker 1115, and a GPS 1120. The communication controller 1080 and the control unit 1085 may be implemented as a single controller.

The information processing apparatus 4 can perform an operation and communication, with power supplied from the battery unit 1070.

The information processing apparatus 4 can transmit and receive data, for example, according to an NFC interface. The information processing apparatus 4 may use another wireless communication interface.

The battery unit 1070 is a power source for supplying power to the information processing apparatus 4. The battery unit 1070 is, for example, a battery. The battery unit 1070 may be dry batteries, storage batteries, fuel cells, or the like. More specifically, a lithium ion battery may be used as the battery unit 1070. The battery unit 1070 may be provided external to the information processing apparatus 4, and for example, may be an AC adapter connected to a commercial power supply source, or the like.

The operable frequency band of the wireless antenna 1075 is set as a predetermined frequency band corresponding to the NFC.

The wireless antenna 1075 receives commands, addresses, data, information, instructions, signals, or the like, and outputs, to the communication controller 1080, the received commands, addresses, data, information, instructions, signals, or the like. The wireless antenna 1075 outputs the commands, addresses, the data, the information, the instructions, the signals, or the like, which are received from the communication controller 1080. The wireless antenna 1075 is, for example, a PCB pattern antenna.

The communication controller 1080 controls the wireless antenna 1075. The communication controller 1080 can output the commands, the addresses, the data, the information, the instructions, the signals, or the like, which are received from the control unit 1085, through the wireless antenna 1075. The communication controller 1080 can output the data received from the wireless antenna 1075, to the control unit 1085.

The control unit 1085 controls various operation of each unit of the information processing apparatus 4, for example, based on input from the input unit 1100, the wireless communication unit 1105, the imaging unit 1110, and the wireless storage apparatus 3. The control unit 1085 controls each unit of the information processing apparatus 4, based on the input data or the calculation result of the data, and outputs the commands or the like to each unit as necessary.

The control unit 1085 is, for example, a semiconductor chip, a circuit formed on a substrate, or one or more combinations thereof. The control unit 1085 may include at least one of a cache memory and a register to store data temporarily.

The control unit 1085 can output the commands, the addresses, the data, the information, the instructions, the signals, or the like to the wireless antenna 1075 through the communication controller 1080. The control unit 1085 receives the commands, the addresses, the data, the information, the instructions, the signals, or the like which are received from the wireless antenna 1075, and the commands, the addresses, the data, the information, the instructions, the signals, or the like which are read from the wireless storage apparatus 3, through the communication controller 1080.

When writing data into the wireless storage apparatus 3, the control unit 1085 outputs data input from each unit or the calculation result of these data, a write command, and an address, to the communication controller 1080.

The control unit 1085 is electrically connected to each unit of the information processing apparatus 4, and electrically communicates with each unit. In other words, the control unit 1085 is able to receive the data from each unit, and output the data or the calculation result of the data. For example, the control unit 1085 calculates (generates) synthetic image data by highlighting the captured data that is captured by the imaging unit 1110, and can output the synthetic image data to the display unit 1095. For example, the control unit 1085 calculates (generates) a synthetic image data, based on the image data which is read from the storage unit 1090, and is able to output the synthetic image data to the display unit 1095. These are merely examples, and the control unit 1085 receives data from the respective units, and is able to output a calculation result of the data.

In the present embodiment, the control unit 1085 may include the receiving unit 42, the operation determination unit 43, and the content generation unit 44 in FIG. 1. The control unit 1085 may be implemented by hardware, or may be even implemented by the processor executing the software.

The storage unit 1090 outputs the stored data to the control unit 1085, based on communication with the control unit 1085. The storage unit 1090 stores data received from the control unit 1085, based on communication with the control unit 1085. The storage unit 1090 is, for example, a memory controller and a nonvolatile memory. Similar to the nonvolatile memory 32, various kinds of memories are used as the nonvolatile memory. The memory controller controls the nonvolatile memory. The storage unit 1090 may be, for example, a hard disk drive (HDD), a solid state disk (SSD), or the like. In the present embodiment, the storage unit 1090 may include the storage unit 41 in FIG. 1.

The display unit 1095 outputs data received from the control unit 1085 in a form that a user can recognize. The display unit 1095 is, for example, a display. The user can visually recognize the data displayed on the display. Specifically, various kinds of displays such as a liquid crystal display, a plasma display, an organic EL display, and a three-dimensional display may be used for the display unit 1095. The display unit 1095 displays the data received from the control unit 1085, on the display. The display unit 1095 can display, for example, an image or moving image data which is captured by the imaging unit 1110, in approximately real time.

The input unit 1100 outputs the input of the user as input data, to the control unit 1085. The input unit 1100 is, for example, a touch panel provided on the display. If the user touches a position on the display, the input unit 1100 detects the touched position on the touch panel, and outputs position information as input data to the control unit 1085. Specifically, switches arranged in a matrix, or various touch panels of a resistive type, a surface acoustic wave type, an infrared type, an electromagnetic induction type, and an electrostatic capacitance type may be used for the input unit 1100.

The input unit 1100 may be, for example, a microphone. If the user utters a voice, the input unit 1100 may detect the voice, extract the input data by voice conversion, and output the extracted input data to the control unit 1085.

The wireless communication unit 1105 includes a wireless antenna and a wireless controller. The wireless communication unit 1105 transmits and receives data, through wireless communication with the outside. The wireless communication unit 1105 outputs the data received from the outside, to the control unit 1085. The wireless communication unit 1105 transmits data received from the control unit 1085, to the outside.

The imaging unit 1110 can capture one or both of a still image and a moving image. The imaging unit 1110 outputs the captured data (image data), in other words, data of a still image or a moving image data to the control unit 1085. The imaging unit 1110 may capture a code arranged on the surface of the wireless storage apparatus 3. The imaging unit 1110 is, for example, a camera. More specifically, the imaging unit 1110 is, a solid photographing device, for example, a camera using a charge coupled device (CCD) sensor, and a complementary metal oxide semiconductor (CMOS) sensor.

The speaker 1115 outputs the audio data received from the control unit 1085.

The GPS 1120 acquires position information of the information processing apparatus 4, and outputs the position information to the control unit 1085.

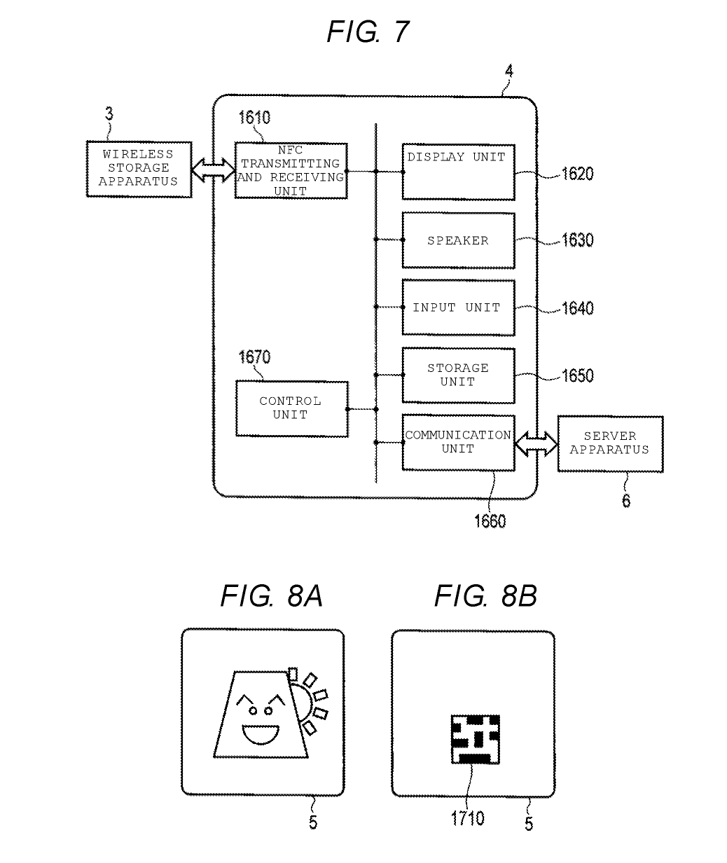

FIG. 7 is a block diagram illustrating a second configuration of the information processing apparatus 4 according to the present embodiment. The information processing apparatus 4 illustrated in FIG. 7 is a station apparatus.

The information processing apparatus 4 includes an NFC transmitting and receiving unit 1610, a display unit (display) 1620, a speaker 1630, an input unit 1640, a storage unit 1650, a communication unit 1660, and a control unit 1670.

The NFC transmitting and receiving unit 1610 performs the NFC communication with apparatuses external to the information processing apparatus 4, in response to the instruction of the control unit 1670. For example, the NFC transmitting and receiving unit 1610 performs the NFC communication with the wireless storage apparatus 3.

The display unit 1620 is, for example, any display such as a liquid crystal display and an organic EL display. The display unit 1620 displays, for example, a message that the wireless storage apparatus 3 is in the NFC communication, and a message that the communication has been completed when the communication has been completed.

The speaker 1630 generates a sound in response to the instruction of the control unit 1670.

The input unit 1640 is, for example, a keyboard or a button. Alternatively, the display unit 1620 is a display, and a touch panel may be used as the input unit 1640.

The storage unit 1650 is, for example, any storage element such as a HDD, an SSD, and a flash memory. The storage unit 1650 stores, for example, data to be transmitted to the outside. Examples of the data include voice data of the character, moving image data, or the like. In the present embodiment, the storage unit 1650 may include the storage unit 41 in FIG. 1.

The communication unit 1660 communicates with, for example, the server apparatus 6, through wired or wireless communication, in response to the instruction of the control unit 1670. The communication unit 1660 acquires data to be stored in the storage unit 1650 from the external server apparatus 6.

The control unit 1670 controls the NFC transmitting and receiving unit 1610, the display unit 1620, the speaker 1630, the input unit 1640, the storage unit 1650, and the communication unit 1660.

In the present embodiment, the control unit 1670 may include the receiving unit 42, the operation determination unit 43, and the content generation unit 44 in FIG. 1. The control unit 1085 may be implemented by hardware, or may be even implemented by the processor executing the software.

FIGS. 8A and 8B schematically illustrate the accessory 5 according to the present embodiment. FIG. 8A is a plan view of one surface (front surface) of the accessory 5. FIG. 8B is a plan view of the other surface (back surface) of the accessory 5.

The accessory 5 includes, for example, a character and a code 1710. The code 1710 can be detected by using the code reader 1320 of the electronic apparatus 2.

In the present embodiment, it is possible to store the data from the electronic apparatus 2, in the wireless storage apparatus 3, and it is possible to actively change the settings of the electronic apparatus 2 on which the wireless storage apparatus 3 is mounted by giving a predetermined instruction to the wireless storage apparatus 3 from the information processing apparatus 4. For example, it is possible to change the content output by the electronic apparatus 2, according to calendar information, position information, personal information, and history information.

In the present embodiment, even if the electronic apparatus 2 is, for example, a stand-alone device that does not have a communication function, since the wireless storage apparatus 3 is mounted on the electronic apparatus 2, the information processing apparatus 4 can change the setting information that is used in the electronic apparatus 2. As a result, it is possible to provide more attractive service to the user, by linking the electronic apparatus 2 and the information processing apparatus 4.

### Second Embodiment

In a second embodiment, the operation of the electronic apparatus 2 according to the first embodiment will be described in more detail.

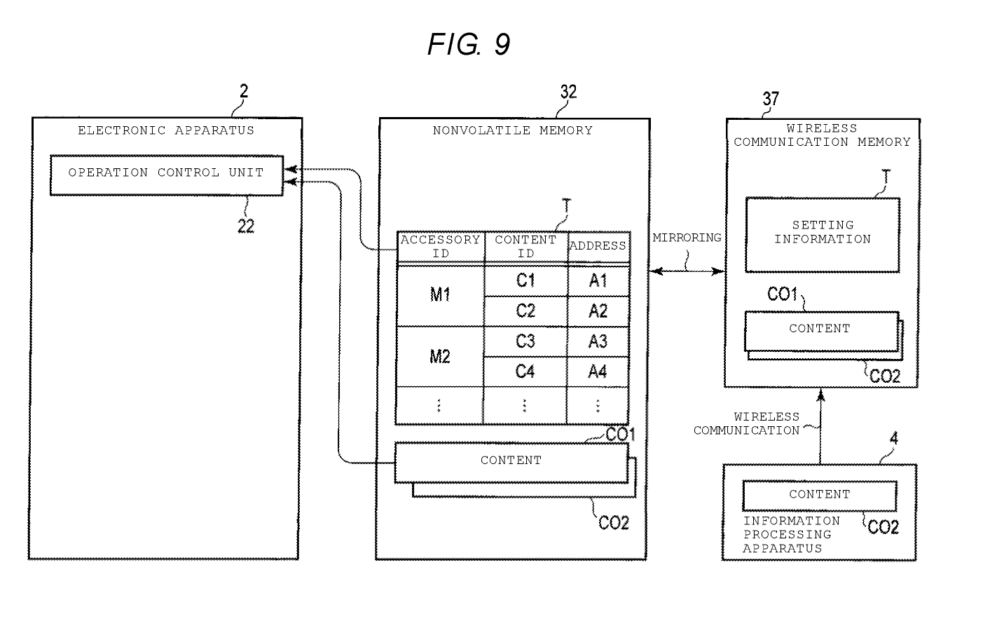

FIG. 9 schematically illustrates a first example of content acquisition by the electronic apparatus 2 according to the present embodiment.

The information processing apparatus 4 changes setting information T that is stored in the wireless communication memory 37 of the wireless storage apparatus 3, by using wireless communication.

The nonvolatile memory 32 stores the changed setting information T about the wireless communication memory 37 by the mirroring.

In the setting information T, for example, the accessory ID, the content ID, and the address are associated. In FIG. 9, for example, M1 as the accessory ID, C1 as the content ID correlated with the accessory ID, and A1 as the address correlated with the content ID are associated. The accessory ID may be associated with a plurality of content IDs.

The nonvolatile memory 32 stores correlated contents CO1 and CO2, in a memory region indicated by each address included in the setting information T.

The operation control unit 22 of the electronic apparatus 2 reads the content CO1 which is stored in the nonvolatile memory 32 and outputs the content CO1, based on the setting information T of the nonvolatile memory 32, the accessory ID M1 indicating the accessory 5 which is mounted, and the content ID C1 which is instructed from the information processing apparatus 4 through the wireless storage apparatus 3.

If the information processing apparatus 4 generates the content CO2, the information processing apparatus 4 stores the generated content CO2 in the wireless communication memory 37 of the wireless storage apparatus 3, by using wireless communication. The information processing apparatus 4 adds the accessory ID M1, a content ID C2, and an address A2, which correspond to the generated content CO2, to the setting information T which is stored in the wireless communication memory 37 of the wireless storage apparatus 3, by using wireless communication. The nonvolatile memory 32 stores the content of the wireless communication memory 37 and the changed setting information T, by the mirroring. Thereafter, the operation control unit 22 reads the generated content CO2 and outputs the generated content CO2, based on the setting information T of the nonvolatile memory 32, the accessory ID M1 indicating the accessory 5 which is mounted, and the content ID C2 which is instructed from the information processing apparatus 4 through the wireless storage apparatus 3.

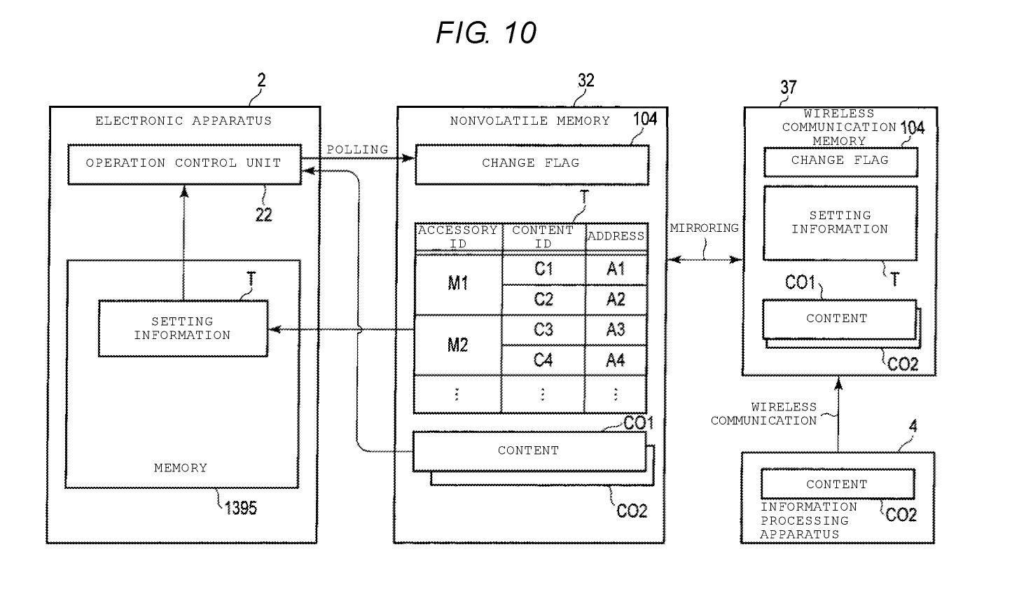

FIG. 10 schematically illustrates a second example of content acquisition by the electronic apparatus 2 according to the present embodiment.

The information processing apparatus 4 changes the setting information T that is stored in the wireless communication memory 37 of the wireless storage apparatus 3, by using the wireless communication, and sets the change flag 104 indicating the change of the setting information T to ON.

The nonvolatile memory 32 stores the change flag 104 of the wireless communication memory 37 and the changed setting information T by the mirroring.

If the change flag 104 is turned ON by polling the change flag 104 of the nonvolatile memory 32, the operation control unit 22 stores the setting information T of the nonvolatile memory 32 in the memory 1395 of the electronic apparatus 2, and turns the change flag 104 OFF.

The operation control unit 22 reads the content CO1 which is stored in the nonvolatile memory 32 and outputs the content CO1, based on the setting information T stored in the memory 1395, the accessory ID M1 indicating the accessory 5 which is mounted, and the content ID C1 which is instructed from the information processing apparatus 4 through the wireless storage apparatus 3.

When reading the content CO1 that is stored in the nonvolatile memory 32, the operation control unit 22 may store the read content CO1 in a predetermined memory area correlated with the accessory ID M1 indicating the accessory 5 which is mounted, and the content ID C1 which is instructed, among the memory 1395. Then, the operation control unit 22 may read the content CO1 from a predetermined memory area of the memory 1395, based on the accessory ID M1 indicating the accessory 5 which is mounted, and the content ID C1 which is instructed.

In FIG. 10, the operation control unit 22 determines the change of the setting information T, based on the change flag 104. Alternatively, the operation control unit 22 may compare, for example, the setting information T stored in the nonvolatile memory 32 with the setting information T stored in the memory 1395, and may detect that the setting information T is changed if they do not match.

The operation control unit 22 may extract a portion different from the setting information T stored in the memory 1395, among the setting information T of the nonvolatile memory 32, and change the setting information T which is stored in the memory 1395 based on the extracted portion.

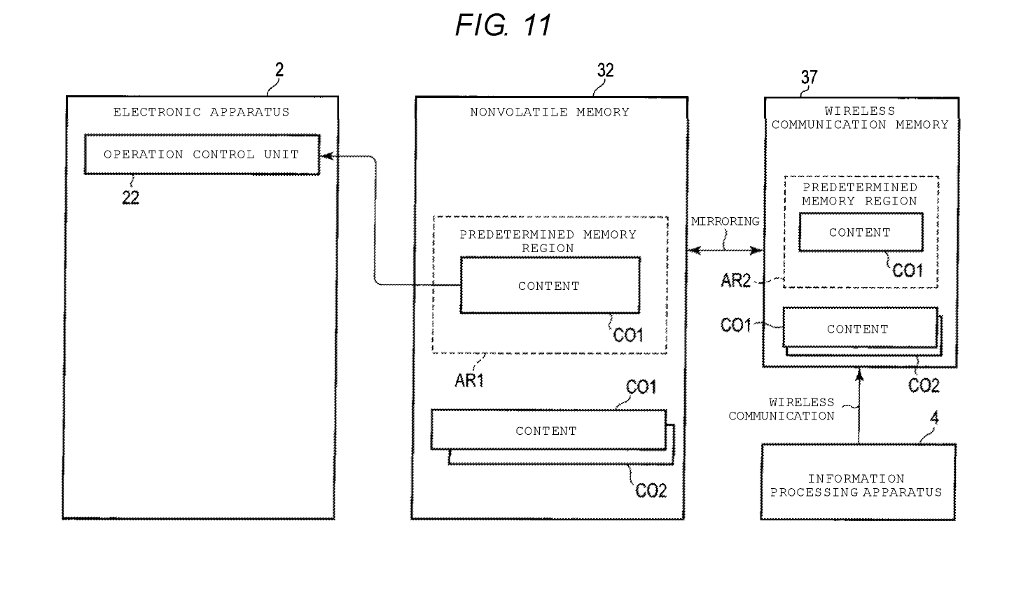

FIG. 11 schematically illustrates a third example of content acquisition by the electronic apparatus 2 according to the present embodiment.

For example, the operation control unit 22 determines in advance a predetermined memory region AR1 (a predetermined address) which stores the content to be output, for the accessory ID and the content ID.

In this case, the information processing apparatus 4 gives an instruction to store the content to be output, in a predetermined memory region AR2 among the wireless communication memory 37 of the wireless storage apparatus 3, by using wireless communication.

The wireless communication memory 37 stores the content CO1 to be output, in the predetermined memory region AR2, based on the instruction from the information processing apparatus 4.

The nonvolatile memory 32 stores the content CO1 to be output from the predetermined memory region AR2 of the wireless communication memory 37, in the predetermined memory region AR1 of the nonvolatile memory 32, by the mirroring.

The operation control unit 22 of the electronic apparatus 2 reads the content CO1 which is stored in the predetermined memory region AR1 of the nonvolatile memory 32, and outputs the content CO1, based on the accessory ID of the accessory 5 which is mounted, and the content ID which is instructed from the information processing apparatus 4 through the wireless storage apparatus 3.

If the content CO2 is generated by the information processing apparatus 4, the information processing apparatus 4 may give an instruction to store the generated content CO2 in the predetermined memory region AR2 of the wireless communication memory 37 by using wireless communication.

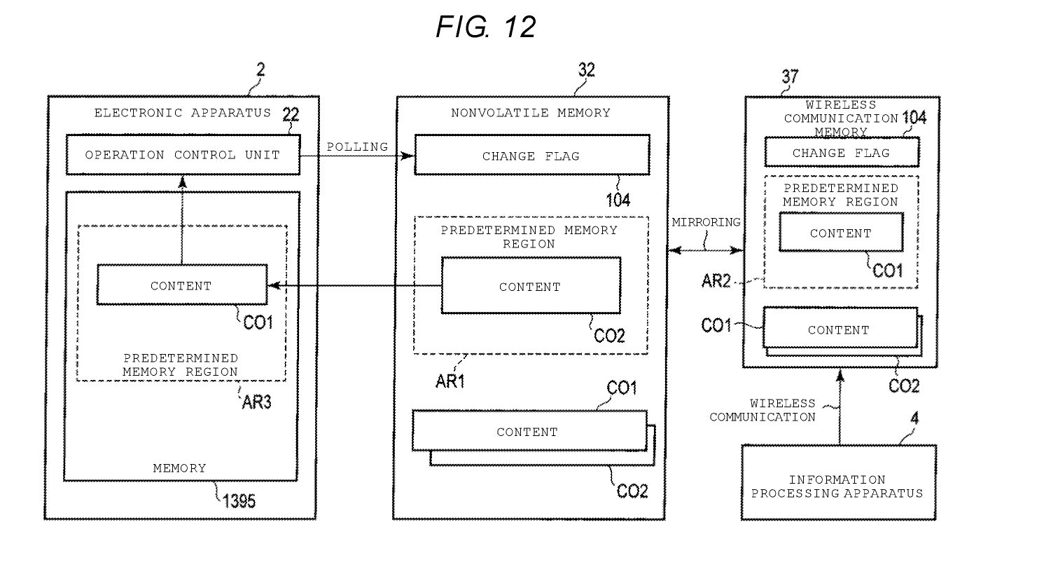

FIG. 12 schematically illustrates a fourth example of content acquisition by the electronic apparatus 2 according to the present embodiment.

For example, the operation control unit 22 determines in advance to store the content CO1 to be output in a predetermined region AR3 of the memory 1395 of the electronic apparatus 2, for the accessory ID and the content ID.

For example, the information processing apparatus 4 gives an instruction to turn ON the change flag 104 indicating the change of the content to be output, by using wireless communication, and to store the content CO1 to be output in the predetermined memory region AR2 of the wireless communication memory 37 of the wireless storage apparatus 3.

The wireless communication memory 37 stores the change flag 104 indicating the change of the content, and stores the content CO1 to be output in the predetermined memory region AR2, based on the instruction from the information processing apparatus 4.

The nonvolatile memory 32 stores the change flag 104 of the wireless communication memory 37, and stores the content CO1 to be output from the predetermined memory region AR2 of the wireless communication memory 37, in the predetermined memory region AR1 of the nonvolatile memory 32, by mirroring.

If the change flag 104 is turned ON by polling the change flag 104 of the nonvolatile memory 32, the operation control unit 22 of the electronic apparatus 2 stores the content CO1 stored in the predetermined memory region AR1 of the nonvolatile memory 32, in the predetermined memory region AR3 of the memory 1395 of the electronic apparatus 2, and sets the change flag 104 to OFF.

The operation control unit 22 reads the content CO1 which is stored in the predetermined memory region AR3 of the memory 1395, and outputs the content CO1, based on the accessory ID of the accessory 5 which is mounted, and the content ID which is instructed from the information processing apparatus 4 through the wireless storage apparatus 3.

In the present embodiment described above, the electronic apparatus 2 can output the content CO1 correlated with the accessory ID indicating the accessory 5 mounted on the electronic apparatus 2 and the content ID which is instructed from the information processing apparatus 4 through the wireless storage apparatus 3.

### Third Embodiment

In a third embodiment, a modification example of the first and second embodiments will be described.

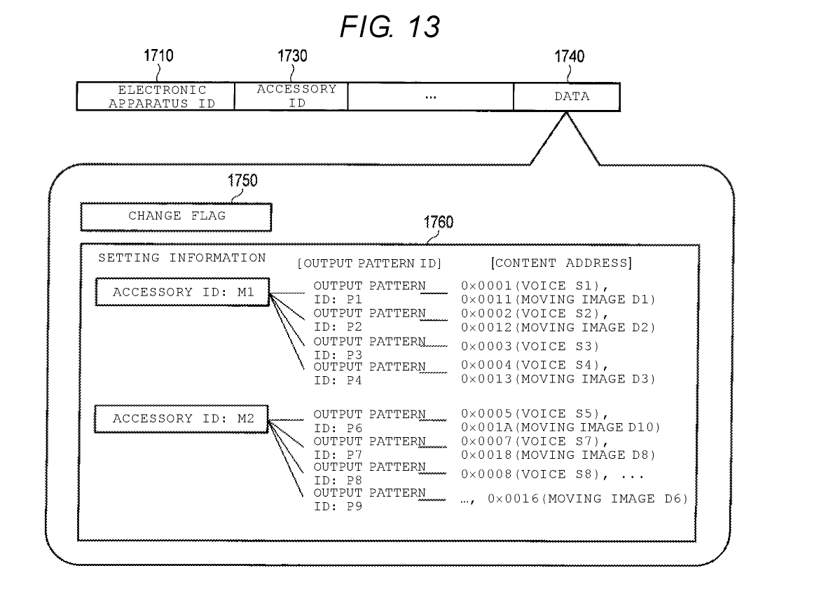

FIG. 13 illustrates a data structure of data to be mirrored according to the present embodiment.

The data to be mirrored includes, for example, an electronic apparatus ID 1710 indicating the version of the current electronic apparatus 2, an accessory ID 1730 that the current electronic apparatus 2 uses, and data 1740.

The data 1740 includes a change flag 1750, and setting information 1760. The change flag 1750 is referred to by the electronic apparatus 2 when polling the change of the data to be mirrored.

The setting information 1760 manages the address of the content that the electronic apparatus 2 outputs in association with, for example, the accessory ID and the pattern in which the content is output (hereinafter, referred to as a output pattern).

For example, when the electronic apparatus 2 uses the accessory of the accessory ID M1, the content that is output in an output pattern ID P1 is voice data S1 and moving image data D1. Similarly, an address of the content to be output is associated with another accessory ID and another output pattern ID. Although FIG. 13 illustrates a case that the content associated with the setting information is voice data and moving image data, the content may be associated with, for example, content of another type such as music data or image data.

The data to be mirrored may be stored in the form of a configuration file. In this case, any file system is employed in the nonvolatile memory 32 and the wireless communication memory 37. The data to be mirrored may include another data which is not illustrated in FIG. 13.

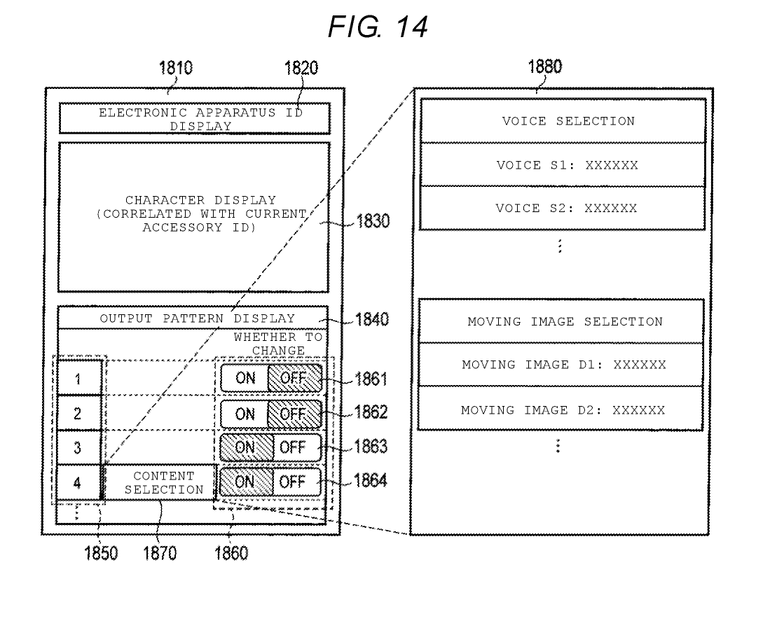

FIG. 14 schematically illustrates a user interface of the information processing apparatus 4 according to the present embodiment. Although FIG. 14 exemplifies, for example, the user interface of the information processing apparatus 4 that is a mobile phone such as a smartphone, the same interface can be displayed on the information processing apparatus 4 that is a station apparatus, or the like.

The information processing apparatus 4 acquires the data to be mirrored which is stored in the wireless communication memory 37 of the wireless storage apparatus 3, by the wireless communication with the wireless storage apparatus 3.

A user interface 1810 of the information processing apparatus 4 includes, for example, an electronic apparatus ID display 1820, a character display 1830, and an output pattern display 1840.

The electronic apparatus ID display 1820 is the display of the electronic apparatus ID 1710 which is acquired by the information processing apparatus 4 through wireless communication with the wireless storage apparatus 3.

The character display 1830 is the display of the image data or the video data which is associated with the accessory ID 1730 which is acquired by the information processing apparatus 4 through wireless communication with the wireless storage apparatus 3. The information processing apparatus 4 or the server apparatus 6 may associate the accessory ID 1730 with the image data or the video data of the character. The user can know which accessory the current electronic apparatus 2 uses, from the character display 1830.

The output pattern display 1840 displays whether to change the setting information 1760, which is acquired by the information processing apparatus 4 through the wireless communication with the wireless storage apparatus 3, for each output pattern ID 1850 of the electronic apparatus 2.

A change permit button 1860 for selecting whether to change the setting information 1760 for each output pattern ID is provided in the output pattern display 1840. Using the change permit button 1860, the user can select whether to change the setting information 1760 for each output pattern ID.

After setting the change permit button 1860 for each output pattern ID, the information processing apparatus 4 can transmit the changed setting information 1760 of the selected output pattern to the wireless storage apparatus 3, by performing wireless communication with the wireless storage apparatus 3.

Hereinafter, the change of the setting information 1760 of each output pattern ID will be described with reference to a specific example.

The output pattern ID P1 and an output pattern ID P2 are associated with each other, for example, when change in the state of the electronic apparatus 2 is detected. For example, the output pattern ID P1 is a combination of content to be output when the power switch 1360 is turned ON/OFF, and the output pattern ID P2 is a combination of content to be output if the accessory 5 is detached or attached, or the input unit 1370 is operated.

If the change permit button 1861 of the output pattern ID P1 is set to ON, the information processing apparatus 4 changes the address of the content of the output pattern ID P1 associated with the current accessory ID, among the setting information 1760. The same is applied to the output pattern ID P2 and the selection button 1862. The information processing apparatus 4 may acquire information required for change, for example, by accessing the server apparatus 6 or a predetermined website. If the information processing apparatus 4 does not have the information required for change, the change may not be performed.

An output pattern ID P3 may be, for example, a combination of content that is output in conjunction with the position or time information that the information processing apparatus 4 has. The information processing apparatus 4 may select the content associated with the position information which is acquired from the GPS 1120 included in the information processing apparatus 4. The information processing apparatus 4 may select the content associated with the time information that the control unit 1085 of the information processing apparatus 4 has. The information processing apparatus 4 can use various pieces of information in order to select the content.

If the change permit button 1863 of the output pattern ID P3 is set to ON, the information processing apparatus 4 changes the address of the content of the output pattern ID P3 which is associated with the current accessory ID among setting information 1760 to the address of the selected content.

An output pattern ID P4 may be, for example, a combination of content that the user selects by using the information processing apparatus 4. For example, a content selection button 1870 is provided on the information processing apparatus 4, and content such as the voice data or the moving image data may be selected on a content selection screen 1880 of a separate screen. Alternatively, as long as the content can be selected, the content selection button 1870 is not necessarily required.

If the change permit button 1864 of the output pattern ID P4 is set to ON, the information processing apparatus 4 changes the address of the content of the output pattern ID P4 which is associated with the current accessory ID among the setting information 1760 to the address of the selected content.

It should be noted that a method of setting the electronic apparatus 2 to a state of outputting the content correlated with each output pattern is defined arbitrarily by the electronic apparatus 2 in the present embodiment.

In addition, allocation of the output pattern is not limited to the above example. The number of output patterns may be fixed in advance by the electronic apparatus 2, or may be different for each accessory ID. If the number of output patterns is different for each accessory ID, the information processing apparatus 4 may compare the current accessory ID 1730 acquired by wireless communication with the accessory ID of the setting information 1760, and display buttons 1850 of the number same as output patterns of the matched accessory IDs.

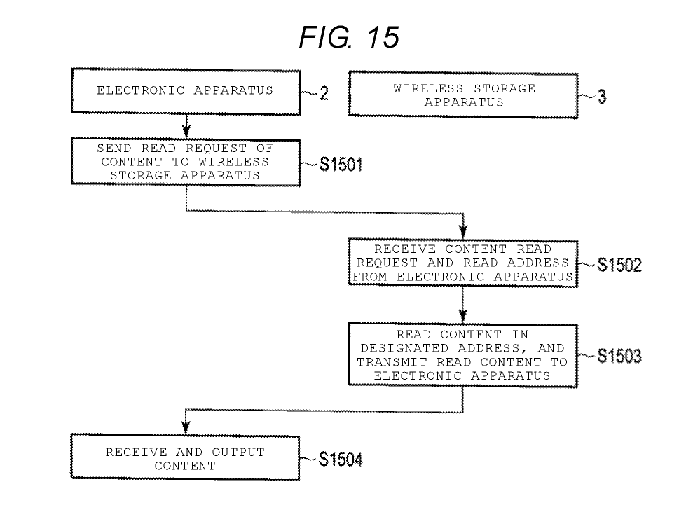

FIG. 15 is a flow chart illustrating a content output process according to the present embodiment, which is a procedure of step S204 in FIG. 2.

The electronic apparatus 2 makes a read request of content correlated with the wireless storage apparatus 3, when outputting the content, in step S1501. The electronic apparatus 2 has the read address of the content for each output pattern, and transmits the read address as well as the read request to the wireless storage apparatus 3.

Next, the wireless storage apparatus 3 receives the content read request and the read address from the electronic apparatus 2, in step S1502.

The wireless storage apparatus 3 reads the content in the designated address, and transmits the read content to the electronic apparatus 2, in step S1503.

The electronic apparatus 2 receives the content from the wireless storage apparatus 3, and outputs the received content, in step S1504.

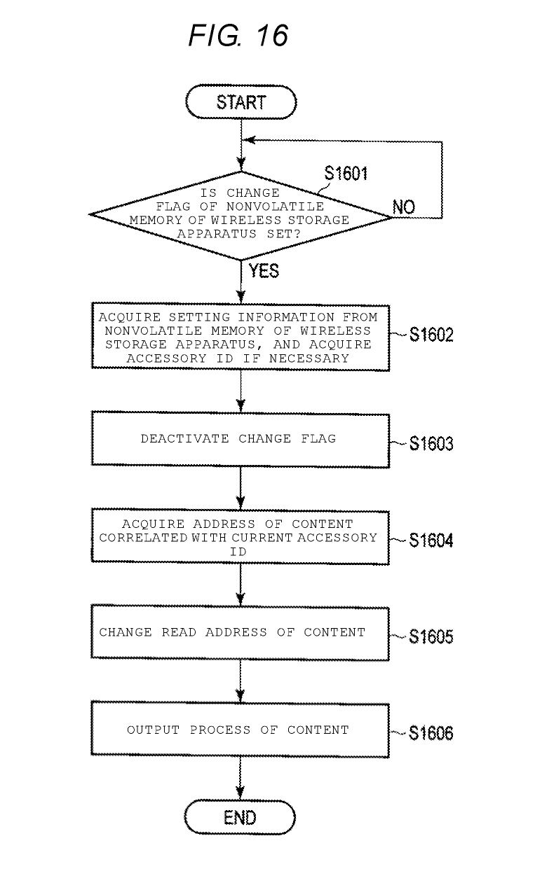

FIG. 16 is a flow chart illustrating an acquisition process of changed setting information according to the present embodiment, which is a procedure of steps S212 and S213 in FIG. 2.

In the present embodiment, it is assumed that the electronic apparatus 2 can actively acquire the changed setting information 1760, for example, by polling, or the like.

In step S1601, the electronic apparatus 2 performs polling of the change flag 1750 stored in the nonvolatile memory 32 of the wireless storage apparatus 3. If the change flag 1750 is not set, polling is continued until the change flag 1750 changes.

If the change flag 1750 is set, the electronic apparatus 2 acquires the setting information 1760 from the nonvolatile memory 32 of the wireless storage apparatus 3 and acquires the accessory ID 1730 if necessary in step S1602, and deactivates the change flag 1750 in step S1603.

The electronic apparatus 2 acquires the address of the content correlated with the current accessory ID, for all output patterns, from the acquired setting information 1760, in step S1604, and changes the read address of the content that the current electronic apparatus 2 has, based on the address of the acquired content, in step S1605.

In step S1606, the electronic apparatus 2 outputs the content, as a result of the same process as the process illustrated in FIG. 15 being performed.

In the present embodiment, the electronic apparatus 2 performs the output of the content based on the address of the changed contents, at the same time of the change of the setting information, by recognizing the change of the setting information by the polling. As a result, the electronic apparatus can directly output the changed content without the operation of the user, and indicate that the change is performed, to the user.

If the electronic apparatus 2 cannot perform the polling, for example, the user may notify the electronic apparatus 2 of the timing to change the read address of the content that the electronic apparatus 2 has.

In the present embodiment, since the information processing apparatus 4 can change the setting information to which the electronic apparatus 2 refers, by performing the wireless communication with the wireless storage apparatus 3. As a result, the user can change the content which is output by the electronic apparatus 2, at any timing.

In the present embodiment, the information processing apparatus 4 determines the content to be output by the electronic apparatus 2, by using the calendar information 45, the position information 46, or the personal information 47 of the user, which is held by the information processing apparatus 4. For example, toys in the related art output a fixed content, but the toy which is an example of the present embodiment can output different content depending on the operation of the user.

In the present embodiment, the information processing apparatus 4 changes the setting information for each output pattern. Thus, the user can select and change only the content to be desired to be changed, among the content that the electronic apparatus 2 outputs.

### Fourth Embodiment

In a fourth embodiment, a modification example of the first to third embodiments will be described.

In the present embodiment, a description will be given on a content output process when it is not possible to change the read address of the content that the electronic apparatus 2 has, or when the electronic apparatus 2 outputs the content until the read address of the content is changed after the setting information is changed. In other words, in the present embodiment, it is assumed that the electronic apparatus 2 outputs the changed content without acquiring the setting information 1760, in S212 in FIG. 2.

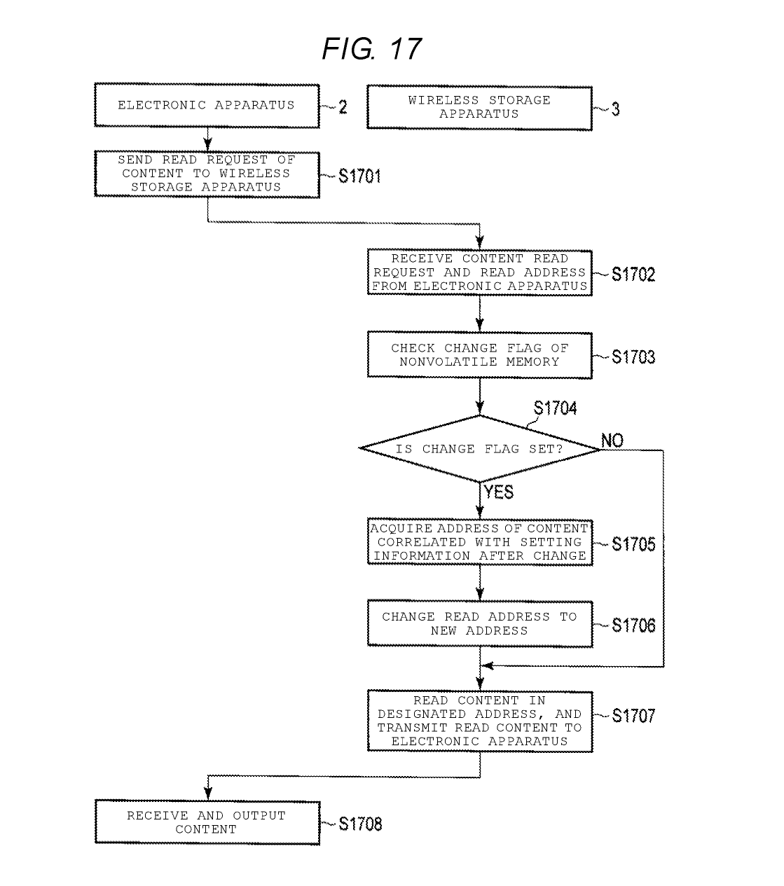

FIG. 17 is a flow chart illustrating a content output process according to the present embodiment.

Steps S1701 and S1702 are the same as S1501 and S1502 in FIG. 15. In other words, the electronic apparatus 2 transmits the read request and the read address of the correlated content to the wireless storage apparatus 3. The wireless storage apparatus 3 receives the read request and the read address of the content from the electronic apparatus 2.

In step S1703, the wireless storage apparatus 3 checks the state of the change flag 1750 of the nonvolatile memory 32.

If the change flag 1750 is not set in step S1704, the wireless storage apparatus 3 does not need to change the read address received from the electronic apparatus 2. For that reason, the process proceeds to the content output process of steps S1707 and step S1708. If the change flag is set, the wireless storage apparatus 3 acquires the address of the content correlated with the setting information after change in step S1705. For example, the wireless storage apparatus 3 may prepare in advance a conversion table in which the setting information before change and the setting information after change are correlated with each other, and convert the read address received from the electronic apparatus 2 to the address after the change by using the conversion table. When the wireless storage apparatus 3 is able to recognize the current output pattern ID, the wireless storage apparatus 3 may acquire the address of the content correlated with the current accessory ID and the output pattern ID from the changed setting information.

The wireless storage apparatus 3 changes the read address received from the electronic apparatus 2 to the address after the change, in step S1706.

Steps S1707 and S1708 are the same as S1503 and S1504 in FIG. 15. In other words, the wireless storage apparatus 3 reads the content of the designated address, and transmits the content to the electronic apparatus 2. The electronic apparatus 2 receives the content from the wireless storage apparatus 3, and outputs the received content.

In the present embodiment, if the setting information is changed and the electronic apparatus 2 does not change the setting information, the wireless storage apparatus 3 converts the read address of the content received from the electronic apparatus 2 into the address of the changed content. As a result, even if the electronic apparatus 2 cannot change the setting information, it is possible to output the changed content.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method comprising:
capturing a code of an accessory that is coupled with a host apparatus, the code containing an accessory ID of the accessory;
storing the accessory ID in a portable memory device that is coupled with the host apparatus, the portable memory device having a nonvolatile memory region in which the accessory ID is initially stored and a wirelessly-communicable memory region;
copying the accessory ID from the nonvolatile memory region to the wirelessly-communicable memory region, the accessory ID being output from the wirelessly-communicable memory region to a user computing device when the user computing device comes within a predetermined communication range of the wirelessly-communicable memory region;
upon detecting that content data associated with the accessory ID are returned from user computing device, storing the content data in the wirelessly-communicable memory region and copying the content data stored in the wirelessly-communicable memory region to the nonvolatile memory region;
reading the content data stored in the nonvolatile memory region; and
generating audio or visual information corresponding to the content data.

2. The method according to claim 1, wherein
the accessory ID is output from the wirelessly-communicable memory region and the content data are stored in the wirelessly-communicable memory region, using power generated by a current induced in the portable memory device by the user computing device when the user computing device comes within the predetermined communication range.

3. The method according to claim 2, wherein
the content data are copied to the nonvolatile memory region and read from the nonvolatile memory region, using power supplied from the host apparatus.

4. The method according to claim 1, further comprising:
causing an update flag to be set in the nonvolatile memory region when the content data stored in the nonvolatile memory region in association with the accessory ID have changed; and
determining that the update flag is set, wherein
the content data are copied to the nonvolatile memory region as a result of determining that the update flag is set.

5. The method according to claim 4, further comprising:
storing the content data copied to the nonvolatile memory region in an internal memory of the host apparatus, wherein
the audio or visual information is generated based on the content data stored in the internal memory of the host apparatus.

6. The method according to claim 1, wherein
the content data are copied into a predetermined memory region of the nonvolatile memory region that is associated with the accessory ID, and
the content data are read from the predetermined memory region by designating the accessory ID.

7. The method according to claim 1, wherein
the content data are copied into a predetermined memory region of the nonvolatile memory region that has an address associated with the accessory ID, and
the content data are read from the predetermined memory region by designating the address.

8. A battery-powered handheld electronic apparatus, comprising:
a housing including a coupler for an accessory and a connector for a portable memory device;
a code reader configured to read a code of an accessory that is coupled with the coupler, the code containing an accessory ID of the accessory; and
a controller configured to write the accessory ID of the accessory that is coupled with the coupler in a nonvolatile memory region of a portable memory device that is connected to the connector, and read content data from the nonvolatile memory region of the portable memory device and cause audio or visual information corresponding to the content data to be generated, wherein
the content data are associated with the accessory ID and stored in the nonvolatile memory region after the controller writes the accessory ID of the accessory in the nonvolatile memory region.

9. The apparatus according to claim 8, wherein
the controller writes the content data read from the memory card into an internal memory of the apparatus, and
the audio or visual information is generated based on the content data written in the internal memory.

10. The apparatus according to claim 8, wherein
the content data are copied into a predetermined memory region of the nonvolatile memory region that is associated with the accessory ID, and
the content data are read from the predetermined memory region by designating the accessory ID.

11. The apparatus according to claim 8, wherein
the content data are copied into a predetermined memory region of the nonvolatile memory region that has an address associated with the accessory ID, and
the content data are read from the predetermined memory region by designating the address.

12. The apparatus according to claim 8, wherein
the content data are also associated with at least one of user information of a user, a predetermined date, a predetermined geographical location, and use history of the accessory or the host apparatus.

13. A semiconductor portable memory device connectable with a host device, comprising:
a nonvolatile memory region;
an antenna;
a communication controller including a wirelessly-communicable memory region, the communication controller configured to transmit and receive data of the wirelessly-communicable memory region wirelessly using an induction current generated at the antenna in accordance with radio waves received from an external device by the antenna; and
a control module that
stores, in a first table set in the nonvolatile memory region, an ID received from the host device with which the semiconductor portable memory device is connected,
causes the ID stored in the first table to be stored in a second table set in the wirelessly-communicable memory region,
causes the ID stored in the second table to be transmitted to the external device through the antenna, when the external device is within a predetermined communication range,
stores content data returned from the external device in the wirelessly-communicable memory region in association with the ID, and then
copies the content data stored in the wirelessly-communicable memory region to the nonvolatile memory region in association with the ID.

14. The device according to claim 13, wherein
the content data are copied to the nonvolatile memory region and read from the nonvolatile memory region, using power supplied from the host device.

15. The device according to claim 13, wherein
the control module causes an update flag to be set in the nonvolatile memory region when the content data stored in the nonvolatile memory region in association with the accessory ID have changed, and copies the content data to the nonvolatile memory region when the update flag is set.

16. The device according to claim 13, wherein
the content data are copied into a predetermined memory region of the nonvolatile memory region that is associated with the accessory ID, and
the content data are read from the predetermined memory region by designating the accessory ID.

17. The device according to claim 13, wherein
the content data are copied into a predetermined memory region of the nonvolatile memory region that has an address associated with the accessory ID, and
the content data are read from the predetermined memory region by designating the address.
